(19) United States
(12) Patent Application Publication
(10) Pub. No.: US 2002/0111904 A1
(43) Pub. Date: Aug. 15, 2002

(54) Method and system for soliciting charitable donation during electronic commerce

(76) Inventors: Harry E. Gruber, Rancho Santa Fe, CA (US); Jeane S. Chen, San Diego, CA (US); Ying-Yen Jan, San Diego, CA (US); Ephraim Feig, San Diego, CA (US)

Correspondence Address: KINTERA INC., 9605 SCRANTON ROAD, SUITE 240, SAN DIEGO, CA, 92121, US

(21) Appl. No.: 09/782,722

(22) Filed: Feb. 13, 2001

(51) Int. Cl. G06F 17/60

(52) U.S. Cl. 705/39; 705/30; 705/26

(57) ABSTRACT

A method and system for soliciting charitable donations from on-line shoppers during electronic commerce is provided. The method for soliciting a charitable donation for an organization or a person from on-line shoppers during electronic commerce comprises the steps of hosting a website having information about a fundraising campaign or an organization, one or more electronic catalogs listing one or more items or events that are available for purchase by the on-line shoppers through the web site, browsing through the catalog and selecting one or more items that are to be purchased, purchasing one or more selected items, adding the selected items to a shopping cart, providing billing information, and providing information regarding one or more charities, wherein the information is intended to encourage and motivate shoppers to make a charitable donation. The method further includes the steps of providing one or more suggestions on the amount of donation, the suggestions intended to encourage and motivate a shopper to make a donation, determining whether to make a voluntary donation to the charitable cause, and making a donation to the charitable cause. The method further includes the step of viewing and changing the quantities of items in the shopping cart. The method further comprises the step of displaying one or more virtual plaques honoring donors and updating the virtual plaques when a donation is made. The method further comprises the step of providing information about the amount of money the fundraising campaign intends to raise and the plans regarding the amount raised. The method further comprises the step of suggesting a donation amount that will allow the charity to reach its goals.

### BACKGROUND

1. Field of Invention

The present invention relates generally to soliciting charitable donations on-line. More specifically, the present invention relates to a method and system for soliciting a charitable donation from on-line shoppers during electronic commerce.

2. Related Art

This application is related to prior applications titled “SYSTEM AND METHOD FOR INTERACTIVE FUNDRAISING OVER A WIDE AREA NETWORK”, filed Dec. 12, 2000, Attorney Docket No. 0001.US00, and “METHOD AND SYSTEM FOR AN EFFICIENT FUNDRAISING CAMPAIGN OVER A WIDE AREA NETWORK,” filed Jan. 17, 2001, Attorney Docket No. 0002.US00. The subject matters of the above-referenced prior applications are incorporated herein by reference in their entirety for all purposes.

### DESCRIPTION OF PRIOR ART

The Internet is increasingly being used to conduct “electronic commerce.” The Internet comprises a vast number of computers and computer networks that are interconnected through communication links that facilitate electronic communications between vendors and purchasers. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction.

The Internet is well suited for electronic commerce because it uses standardized techniques for exchanging information. The world wide web (“www”) of the Internet allows a server computer system, i.e., a web server, to send graphical web pages of information to a remote client computer system. The remote client computer system can then display the web pages. Each web page of the www is uniquely identifiable by a Uniform Resource Locator (“url”). To view a specific web page, a client computer specifies the url for that web page in a request, e.g., a Hyper Text Transfer Protocol (“http”) request. The request is forwarded to the web server that supports that web page. When the web page server receives the request, it sends that web page to the client computer system. When the client computer system receives that web page, it typically displays the web page using a browser. A browser is typically a special purpose application that affects the requesting of web pages and the displaying of web pages.

The world wide web of the Internet is especially conducive to conducting electronic commerce. Many web servers have been developed through which vendors can advertise and sell products. The products can include items (e.g., compact disks, books, magazines, etc.) that are delivered through conventional distribution channels (e.g., common carrier). A server computer system may provide an electronic version of a catalog that lists the items that are available. A purchaser may browse through the catalog using a browser and select various items that are to be purchased. When the purchaser has completed selecting the items to be purchased, the server computer system then prompts the purchaser for information to complete the ordering of the items. This purchaser-specific order information may include the purchaser's name, the purchaser's credit card number, and a shipping address for the order. The server computer system then typically confirms the order by sending a confirming web page to the client computer system and schedules shipment of the items.

The Internet has also been recognized as having potential in the area of fundraising. Charitable, nonprofit and other organizations have recognized the power of the Internet in augmenting their fundraising campaigns. These organizations have recognized that the Internet can increase the efficiency of a fundraising campaign by replacing or augmenting traditional marketing techniques such as traditional donation solicitation, manual collection of donations and other time-intensive schemes with an efficient and convenient web-based scheme that utilizes the power of the Internet for marketing, solicitations, transactions, data storage and retrieval associated with a fundraising campaign. These organizations have recognized that the Internet allows them to efficiently, conveniently and cost-effectively reach out to an increased number of potential donors, thereby increasing the amount of charitable donations.

Two previously-filed, and now pending, applications titled “SYSTEM AND METHOD FOR INTERACTIVE FUNDRAISING OVER A WIDE AREA NETWORK”, filed Dec. 12, 2000, Attorney Docket No. 0001.US00, and “METHOD AND SYSTEM FOR AN EFFICIENT FUNDRAISING CAMPAIGN OVER A WIDE AREA NETWORK,” filed Jan. 17, 2001, Attorney Docket No. 0002.US00 disclose fundraising on the Internet.

Some web sites allow shoppers to shop on-line and a percentage of the total amount of purchase is automatically donated to a charity. For example, a shopper may spend $100 on-line on one or more merchandise and $10 may automatically be donated to a charity. These systems do not allow shoppers to decide how much they want to donate. Also, these systems do not encourage or motivate shoppers to donate to a charity. Rather these are involuntary schemes whereby a percentage of the total amount of purchase is automatically donated.

Furthermore, heretofore, prior art has not disclosed an intelligent, knowledge-based scheme that incorporates electronic commerce activities to charitable donations. The prior art has not disclosed a scheme that selectively and intelligently influences on-line shoppers by providing information about a charitable cause to make a charitable donation.

### SUMMARY OF THE INVENTION

The present invention provides a method and system for soliciting charitable donations from on-line shoppers during electronic commerce. In one embodiment, a method for soliciting a charitable donation for an organization or a person from on-line shoppers during electronic commerce comprises the steps of hosting a website having information about a fundraising campaign or an organization, one or more electronic catalogs listing one or more items or events that are available for purchase by the on-line shoppers through the web site, browsing through the catalog and selecting one or more items that are to be purchased, purchasing one or more selected items, adding the selected items to a shopping cart, providing billing information, providing information regarding one or more charities, the information intended to encourage and motivate shoppers to make a charitable donation, providing one or more suggestions on the amount of donation, the suggestions intended to encourage and motivate a shopper to make a donation, determining whether to make a voluntary donation to the charitable cause, and making a donation to the charitable cause.

The method further comprises the step of viewing and changing the quantities of items in the shopping cart. The method further comprises the step of displaying one or more virtual plaques honoring donors and updating the virtual plaques when a donation is made. The method further comprises the step of providing information about the amount of money the fundraising campaign intends to raise and the plans regarding the amount raised. The method further comprises the step of suggesting a donation amount that will allow the charity to reach its goals.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a block diagram of an embodiment of the present invention in association with a wide-area network;

FIG. 2 is a flow diagram illustrating the high-level operational steps in accordance with one embodiment of the present invention; and

FIG. 3 illustrates a detailed flow diagram of the sequence-of-method steps in accordance with one embodiment of the invention.

### DETAILED DESCRIPTION OF THE INVENTION

Turning first to the nomenclature of the specification, the detailed description that follows is represented largely in terms of block diagrams, processes and symbolic representations by conventional computer components, including a processor associated with a general-purpose computer system, memory storage devices for the processor, and connected display devices. These operations include the manipulation of data bits by the processor, and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

Also for the purpose of this discussion, a process or method is generally conceived to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, terms, numbers, records, files or the like. It should be kept in mind, however, that these and some other terms should be associated with appropriate physical quantities for computer operations and that these terms are merely conventional labels applied to physical quantities that exist within and during operation of the computer.

In addition, it should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention is directed to a method and system for soliciting a charitable donation during electronic commerce. The invention is an intelligent, knowledge-based scheme that incorporates the increasingly popular electronic commerce activities to charitable donations. The invention selectively and intelligently influences on-line shoppers to make a charitable donation by providing information about a worthy charitable cause. The invention provides information about an organization or a person engaged in a fundraising campaign to benefit a particular cause, such as, for example, a charitable cause. The organization can be a charitable organization, a nonprofit organization, a political organization, a political action committee, a religious organization, a non-governmental organization, an association, or any other entity engaged in raising money for a cause.

The invention motivates and encourages online shoppers by creating a positive environment that induces them to eventually make a charitable donation. The invention provides one or more web pages on which shoppers can conduct electronic commerce, i.e., buy merchandise, and donate to one or more charities. The web pages are accessible via the Internet.

In one aspect, the invention provides on-line shoppers the ability to shop and an option to make a voluntary donation to one or more charitable causes. The invention allows the shopper to decide whether he or she wants to make a donation and the amount of the donation, instead of a pre-set amount.

In one aspect, the invention educates on-line shoppers about the charitable cause by providing them with relevant information. The information about the charity creates an environment that is favorable to charitable giving. The information encourages and motivates on-line shoppers to make a charitable donation or otherwise increase the amount of charitable donation. The information that is likely to encourage and motivate an online shopper to make a donation includes, without limitation, information related to a worthy charitable cause, number of donors that have already donated, virtual plaques that acknowledge and honor donors, virtual plaques that include a profile of donors and comments about the charitable cause, average amount of donation, on-line shopper's friends, family and co-workers that have donated, amounts donated by friends, family and co-workers, amount of donation that will allow the organization to reach its fundraising goal, suggested donation and any amount of previous donations that the online shopper have made.

In one aspect, the invention encourages the on-line shopper to make a donation that is linked to the amount of purchase. For example, the invention suggests that the on-line shopper donate a percentage of the total amount of purchase to the charitable cause. Consider a scenario where an online shopper spends $200 on several items on-line. The invention can suggest that the on-line shopper donate a small percentage, for example, 10% of the total amount of purchase, or $20, to the charitable cause. It is likely that the shopper would be more willing, and less reluctant, to donate a small percentage of the total amount of purchase to a worthy charitable cause. Thus, the invention creates an environment where an online shopper is less reluctant and more willing to make a donation.

In this regard, the invention also provides information to the on-line shopper that encourages them to purchase items. For example, the invention reminds the on-line shopper about various items that the shopper purchased previously. The shopper can be reminded of a recently-purchased favorite item. The shopper can also be shown other items that are popular among other shoppers. Furthermore, when a shopper makes a purchase of a particular item, the shopper can be informed of other items that were purchased by others who also purchased that particular item. These and other schemes encourage the shopper to buy more on-line and that, in turn, induces him to donate more as a percentage of the amount of purchase.

In one embodiment, the invention identifies the geographic location of the on-line shopper and provides information about one or more charities involved in that location. The invention can identify the shopper's geographic location from the shipment information (i.e., address, zip code, etc.) provided during on-line shopping. The geographic location can also be identified from an IP address.

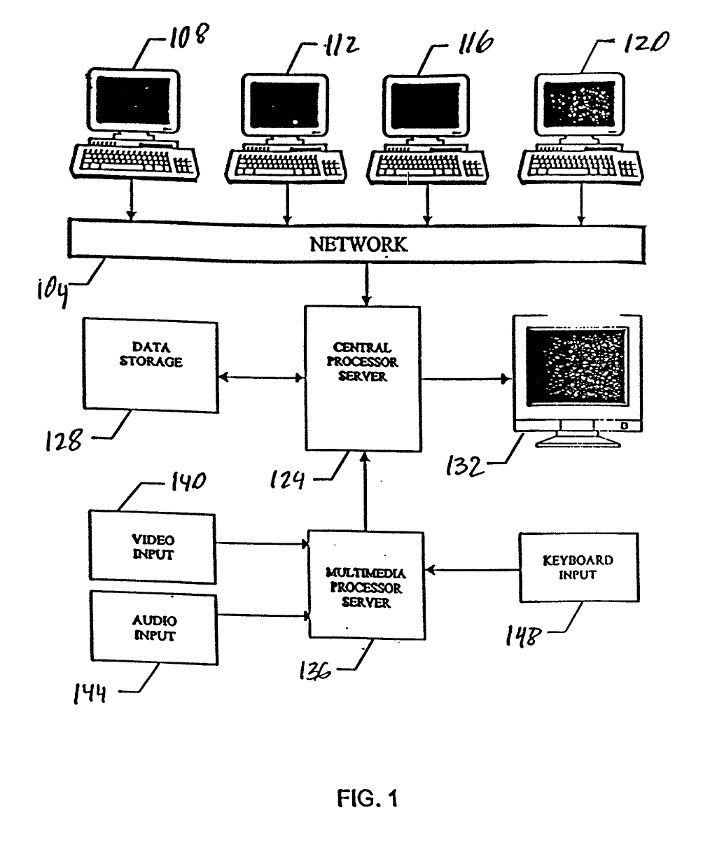

Referring now in more detail to the drawings, FIG. 1 is a block diagram of an embodiment of the present invention in association with a wide-area network. In FIG. 1, a wide-area network, e.g., the Internet, 104 is shown in conjunction with a number of representative user stations 108, 112, 116, and 120. It is well known in the art how to structure such wide-area network connections to provide two-way communication between various stations and locations connected to the network.

In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations.

In one embodiment of the present invention, central processor server 124 would be a computer system established by the fundraising organization or its agent for the purpose of conducting electronic commerce, soliciting contributions and also receiving pledges and donations. In other words, the central processor server 124 can be a fundraising organization/vendor's computer. A purchaser can use a user station to connect via the Internet 104 to the vendor/fundraiser's computer. The purchaser can then interact with the vendor/fundraiser's computer to conduct transaction.

It is to be understood, however, that the central processor server 124 may also be a computer system operated by an organization specifically set up to carry out fundraising and conduct electronic commerce on behalf of a variety of charities and nonprofit organizations. The operation of the system and the methods involved are the same regardless of the nature of the organization that establishes and carries out the on-line functionality of the system.

The central processor server 124 is linked to a data storage device 128 as well as to an appropriate display device 132. These mechanisms simply provide the means for storing information for presentation to the viewers, as well as the means for receiving information from viewers, either for immediate display or recording for later access.

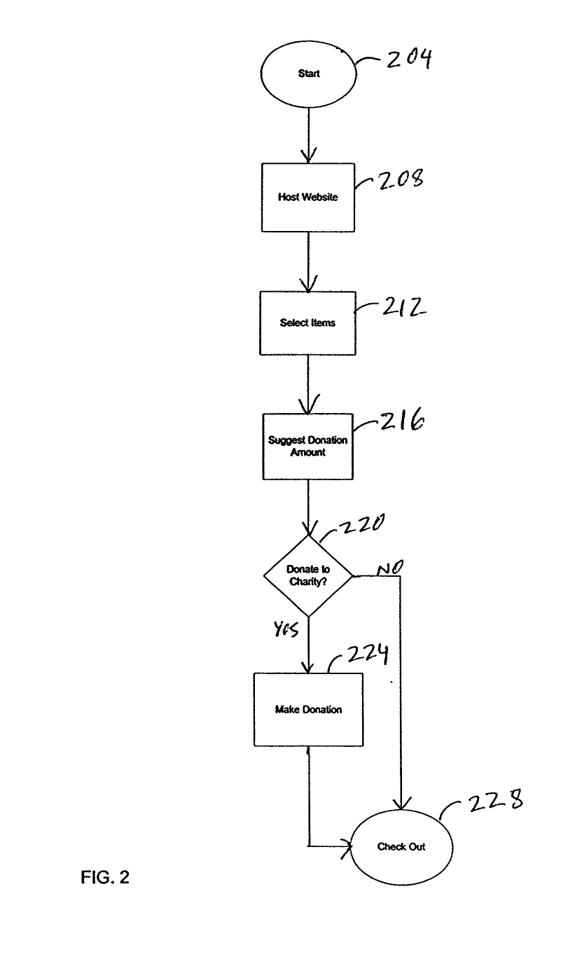

Reference is now made to FIG. 2, wherein a flow diagram illustrates the high-level operational steps for conducting an efficient, web-based electronic commerce and fundraising campaign in accordance with one embodiment of the present invention. The steps are described in further details later.

The flow begins at step 204 and proceeds to step 208 where an organization's website is hosted. It should be understood that the website may also be hosted by a person engaged in a fundraising campaign.

The website includes information about the organization and the fundraising campaign. In other words, the website provides information designed to educate a viewer on a worthy charitable cause.

In addition, the website includes information about various products that are available for purchase from the website. Vendors can advertise and sell these products using the website. In one embodiment, the website may provide an electronic version of a catalog that lists the items that are available. A user, who is a potential purchaser, may browse through the catalog using a browser and select items that are to be purchased.

The website is accessible on the Internet and may be hosted by an organization that is conducting the fundraising campaign or by a third party contracted to assist in the campaign. The organization can be a charitable, a non-profit, a political action committee (PAC), a political organization, or any other organization engaged in a lawful fundraising effort.

The method then proceeds to step 212 wherein a shopper selects to buy one or more items that are available. The method proceeds to step 216 where the shopper is provided with one or more selected suggestions regarding a donation. The suggestions are selected and are intended to encourage a shopper to donate to a charity. The invention also allows shoppers to “opt-out” of a requirement for a donation to not occur. For example, shoppers can check a box on a web page that will allow them to not contribute any amount to a charity. The suggestions are discussed in further detail below. The method then proceeds to decision block 220 where the shopper is given the option to make a voluntary donation to a charitable cause. If the shopper wishes to make a donation, in step 224, the shopper makes a donation. The method then moves to step 228. If the shopper declines to make a donation to the charitable cause, the method moves to step 228.

In one embodiment, the invention provides a shopping cart for the convenience of the shoppers. The shopper is presented with an electronic catalog of items. When the shopper selects an item, the server computer system metaphorically adds that item to the shopping cart. The invention allows the shopper to view and change quantities of the items in the shopping cart. When the shopper is satisfied with the items in the shopping cart, the shopper checks out the items that are in the shopping cart. The shopper may provide billing and shipment information as part of the “check out” process.

In one embodiment, the invention intelligently encourages and motivates shoppers to make a charitable donation. In an effort to encourage and motivate shoppers to make a charitable donation, the invention provides information about the fundraising organization and the charitable cause. More specifically, with regard to the charitable cause, the invention provides, without limitation, one or more of the following information:

Goals and Objectives: The invention provides information about the amount of money the charity intends to raise and what it plans to do with the amount raised.

Donors: The invention provides information about the number of donors who have already contributed.

Virtual Plagues: The invention includes virtual plaques that acknowledge and honor previous donors. The virtual plaques are a convenient means for publicly honoring donors, and they encourage and motivate purchasers to make a donation. The virtual plaques may include a profile, a photo or a video of the donor. In addition, the virtual plaques can include comments made by the donor regarding the charitable cause.

Suggested Donation Amount: The system suggests a donation amount to a member. The following are examples, without limitation, of the various suggested amounts of donation that the system can make.

Amount Equal to Previous Donation: The system suggests that the member donate an amount that is equal to the member's most recent donation. The system may provide additional information about the date and the type of charity to which the member donated most recently.

Percentage of Total Purchase: The system calculates the total amount of purchase made by the purchaser and suggests a donation amount that is a percent of the total amount of purchase.

Amount Needed to Meet Fundraising Goal: The system suggests an amount that will allow the charity to meet its fundraising goal.

Amount Donated by Friends, Families, etc.: The system suggests an amount that is equal to the amount donated by friends, family and co-workers of the member.

Percentage Increase over Recent Donation: The system suggests an amount that is a predetermined increase over the recent donation.

Predefined Voluntary Donation Rate: The charity can define a voluntary donation rate, and the invention can use this rate as a default.

Average Donation: The invention provides information about the average amount of donation.

Donor Review: The invention allows a donor to write a review of the donor's experience of the online shopping, the charity and the donation. Also, the service allows a potential donor to read other donors' review of the charitable cause and their donations.

Prize: The invention provides information about one or more prizes for donors. This information encourages potential donors to make a donation.

In one embodiment, the invention also provides a convenient means for potential donors and shoppers to register and become a member of a charitable organization. When a donor registers to become a member, the system creates a member profile for that donor. The profile includes, without limitation, the following information.

Personal Donation History: The system maintains a record of the member's donation history. A member's donation history can include, without limitation, the types of charity that the member donated to and the amounts of donation. Based on the donation history, the system can suggest that the donor make a donation to a similar type of charity.

In one embodiment of the invention, a personalized recommendation of items based on the collective interests of a community of users is provided. An important feature of the service is that the recommendations are generated without the need for the user to rate items. Another feature is that the recommended items are identified using a previously-generated table or other mapping structure which maps individual items to lists of “similar” items. The item similarities reflected by the table are based at least upon correlations between the interests of users in particular items. The construction of such mapping structures is well known to those skilled in the art.

The items recommended by the system include, without limitation, books, compact disks (“CDs”), videos, magazines, authors, artists, web sites, etc. To generate a set of recommendations for a given user, the system retrieves from the table the similar item lists corresponding to items already known to be of interest to the user, and then appropriately combines these lists to generate a list of recommended items. For example, if there are three items that are known to be of interest to the user (such as three items the user recently purchased), the service may retrieve the similar item lists for these three items from the table and combine those lists. In one embodiment, the item-to-item mappings are regenerated periodically based on up-to-date sales data, and the recommendations tend to reflect the current buying trends of the community.

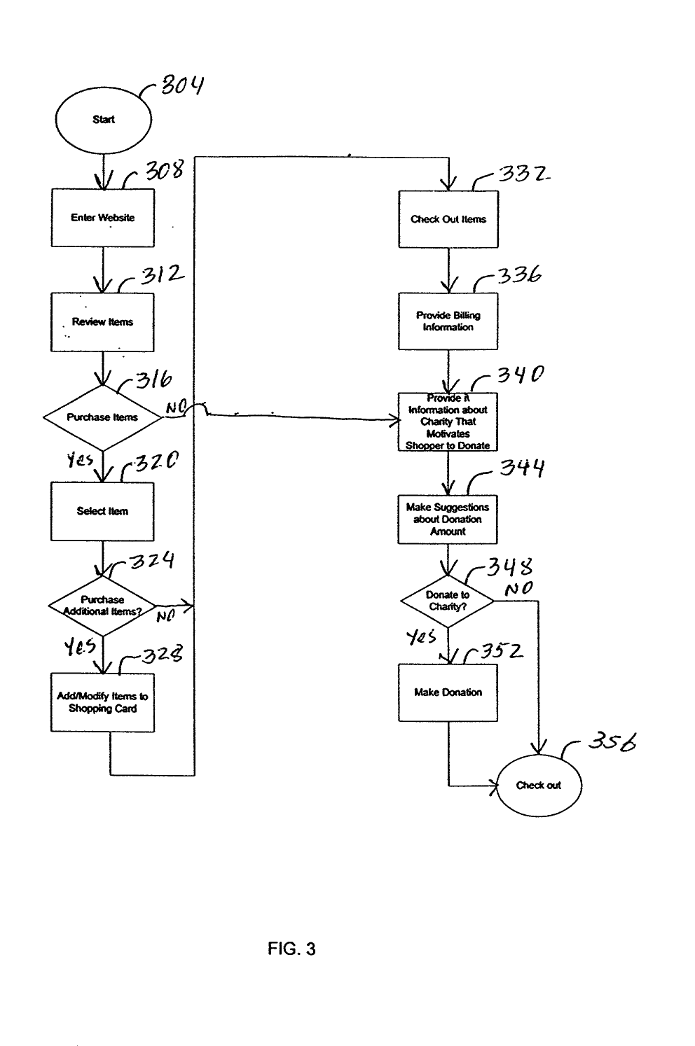

FIG. 3 illustrates a detailed flow diagram of the sequence of method steps in accordance with one embodiment of the invention. The flow starts at step 304 and proceeds to step 308 where a shopper enters an organization (or a person's) website that provides electronic commerce as well as fundraising services. In step 312, the shopper is shown an electronic version of a catalog that lists items that are available. The shopper may browse through the catalog items. In decision block 316, the shopper makes a decision whether to purchase an item. If the shopper decides to make a purchase, the shopper selects the item that is to be purchased in step 320. In step 324, the shopper decides whether to purchase additional items or to make a change to the already-purchased items. As noted before, the selection from the electronic catalog of items is generally based on a shopping cart model. If the shopper decides to make additional purchases, in step 328 the system adds that item to a shopping cart. The system provides web pages that allow the shopper to view and change the quantities of the items in the shopping cart. When the shopper is satisfied with the items that are in the shopping cart, in step 332 the shopper proceeds to the check-out. In step 336, the shopper provides billing and shipment information. The billing information can include credit card information.

In step 340, the shopper is provided with selected information regarding one or more charities. The selected information is intended to encourage and motivate shoppers to make a charitable donation and has been described in detail earlier.

Referring back to step 316, if the shopper declines to make a purchase, the flow moves to step 340. Also, in step 324, if the shopper declines to purchase additional items or change items, the flow returns to step 340.

The flow then proceeds to step 344, where the shopper is provided with one or more suggestions regarding a charitable donation. These suggestions are intended to encourage and influence a buyer to donate. The suggestions include information that has been described in detail earlier. The flow then moves to step 348 where the shopper decides whether to make a charitable donation. If the shopper decides to make a donation, the flow moves to step 352 where the shopper makes a donation. The flow returns to step 356. If, in step 348, the shopper declines to make a donation, the flow returns to step 356.

In one embodiment, the donor is provided with a report that includes various tax-related information. For example, the donor is provided with a web page that lists the amount of charitable donation and the amount that is tax deductible.

In one embodiment, the present invention is a computer program product embodied in a storage medium, such as, for example, a compact disk (CD), a hard drive, a floppy disk, an optical storage device or any other type of storage device. The computer program product includes a program code that is configured to execute the operational method steps of the present invention. The program code can written using any computer language.

Thus, it is apparent that there has been provided, in accordance with the present invention, a system and method for efficiently soliciting charitable donations during electronic commerce. Although the preferred embodiments have been described, it should be understood that various changes, substitutions, and alterations can be made herein without departing from the scope of the present invention. It should be noted that the present invention can be implemented using virtually any computer system or other networking system and virtually any available programming language. Thus, the implementation of the present invention is not limited to the computer network illustrated in this document. Other examples of changes, substitutions, and alterations are readily ascertainable by one skilled in the art and could be made without departing from the spirit and scope of the present invention as defined by the following claims.

What is claimed is:

1. A method for soliciting charitable donation for an organization or a person from on-line shoppers during electronic commerce, the method encouraging and motivating the shoppers to make a donation to a charitable cause, the method comprising the steps of:
hosting a website having information about a fundraising campaign or an organization;
one or more electronic catalogs listing one or more items or events that are available for purchase by the on-line shoppers through the web site;
browsing through the catalog and selecting one or more items that are to be purchased;
purchasing one or more selected items;
providing one or more suggestions on the amount of donation, the suggestions intended to encourage and motivate a shopper to make a donation;
determining whether to make a voluntary donation to the charitable cause; and
making a donation to the charitable cause.

2. The method as recited in claim 1, further comprising the step of displaying one or more virtual plaques honoring donors.

3. The method as recited in claim 2, further comprising the step of updating the virtual plaques when a donation is made.

4. The method as recited in claim 1, further comprising the step of providing information about the amount of money the fundraising campaign intends to raise and the plans regarding the amount raised.

5. The method as recited in claim 1, further comprising the step of suggesting a donation amount that will allow the charity to reach its goals.

6. The method as recited in claim 1, further comprising the step of providing information about the average amount of donation from prior donors.

7. The method as recited in claim 1, further comprising the step of providing reviews written by prior donors about the charitable causes and their donations.

8. The method as recited in claim 1, further comprising the step of allowing donors to write reviews about the charitable cause and their donation.

9. The method as recited in claim 1, further comprising the step of identifying the geographic location of a donor.

10. The method as recited in claim 9, further comprising the step of providing information about charitable activities that the charity is involved in the donor's location.

11. The method as recited in claim 1, further comprising the step of providing a record of the donor's prior donation history.

12. The method as recited in claim 1, further comprising the step of providing information about the donor's prior donation amount.

13. The method as recited in claim 1, further comprising the step of suggesting a donation amount that is a predetermined percentage of the total amount of purchase.

14. The method as recited in claim 1, further comprising the step of providing information about the amount of donation made by the donor's friends, family or co-workers.

15. The method as recited in claim 1, wherein the organization is a charitable organization.

16. The method as recited in claim 1, wherein the organization is a political action committee.

17. The method as recited in claim 1, wherein the organization is a political organization.

18. The method as recited in claim 1, further comprising the step of providing a report having tax related information, the report including the amount of charitable donation and the amount that is tax deductible.

19. The method as recited in claim 18, further comprising the step of e-mailing the report to the donor.

20. A method for soliciting a charitable donation for an organization or a person from on-line shoppers during electronic commerce, the method encouraging and motivating the shoppers to make a donation to a charitable cause, the method comprising the steps of:
hosting a website having information about a fundraising campaign or an organization;
one or more electronic catalogs listing one or more items or events that are available for purchase by the on-line shoppers through the web site;
browsing through the catalog and selecting one or more items that are to be purchased;
purchasing one or more selected items;
adding the selected items to a shopping cart;
providing billing information;
providing information regarding one or more charities, the information intended to encourage and motivate shoppers to make a charitable donation;
providing one or more suggestions on the amount of donation, the suggestions intended to encourage and motivate a shopper to make a donation;
determining whether to make a voluntary donation to the charitable cause; and
making a donation to the charitable cause.

21. The method as recited in claim 20, further comprising the step of viewing and changing the quantities of items in the shopping cart.

22. The method as recited in claim 20, further comprising the step of displaying one or more virtual plaques honoring donors.

23. The method as recited in claim 22, further comprising the step of updating the virtual plaques when a donation is made.

24. The method as recited in claim 20, further comprising the step of providing information about the amount of money the fundraising campaign intends to raise and the plans regarding the amount raised.

25. The method as recited in claim 20, further comprising the step of suggesting a donation amount that will allow the charity to reach its goals.

26. The method as recited in claim 20, further comprising the step of providing information about the average amount of donation from prior donors.

27. The method as recited in claim 20, further comprising the step of providing reviews written by prior donors about the charitable cause and their donation.

28. The method as recited in claim 20, further comprising the step of allowing donors to write reviews about the charitable cause and their donation.

29. The method as recited in claim 20, further comprising the step of identifying the geographic location of a donor.

30. The method as recited in claim 29, further comprising the step of providing information about charitable activities that the charity is involved in the donor's location.

31. The method as recited in claim 30, further comprising the step of providing a record of the donor's prior donation history.

32. The method as recited in claim 20, further comprising the step of providing information about the donor's prior donation amount.

33. The method as recited in claim 20, further comprising the step of suggesting a donation amount that is a predetermined percentage of the total amount of purchase.

34. The method as recited in claim 20, further comprising the step of providing information about the amount of donation made by the donor's friends, family or co-workers.

35. The method as recited in claim 20, wherein the organization is a charitable organization.

36. The method as recited in claim 20, wherein the organization is a political action committee.

37. The method as recited in claim 20, wherein the organization is a political organization.

38. The method as recited in claim 20, further comprising the step of providing a report having tax-related information, the report including the amount of charitable donation and the amount that is tax deductible.

39. The method as recited in claim 20, further comprising the step of e-mailing the report to the donor.

40. A method for soliciting charitable donation for an organization or a person from on-line shoppers during electronic commerce, the method encouraging and motivating the shoppers to make a donation to a charitable cause, the method comprising the steps of:
hosting a website having information about a fundraising campaign or an organization;
one or more electronic catalogs listing one or more items or events that are available for purchase by the on-line shoppers through the web site;
browsing through the catalog and selecting one or more items that are to be purchased;
purchasing one or more selected items;
determining whether to make a voluntary donation to the charitable cause; and
making a donation to the charitable cause.

41. The method as recited in claim 40, further comprising the step of providing one or more suggestions on the amount of donation, the suggestions intended to encourage and motivate a shopper to make a donation.

42. The method as recited in claim 1, further comprising the step of selecting an option to not donate to a charity.

43. The method as recited in claim 20, further comprising the step of selecting an option to not donate to a charity.
